(19) United States
(12) Patent Application Publication
(10) Pub. No.: US 2008/0137185 A1
(43) Pub. Date: Jun. 12, 2008

(54) POST-PROCESSING SLIDE PRINTER AND METHODS OF USE

(75) Inventors: Peter Kruczynski, Amherst, NH (US); Kevin Patenaude, Lowell, MA (US)

Correspondence Address: VISTA IP LAW GROUP LLP, 12930 Saratoga Avenue, Suite D-2, Saratoga, CA, 95070, US

(73) Assignee: CYTYC CORPORATION, Marlborough, MA (US)

(21) Appl. No.: 11/609,807

(22) Filed: Dec. 12, 2006

(51) Int. Cl. G02B 21/34

(52) U.S. Cl. 359/397

(57) ABSTRACT

A slide printing system includes a printer comprising a slide stage and a print head, a first locking mechanism configured to hold a first slide-holding repository, and a slide handler configured to rotate about an axis for transporting a specimen slide from a slide-holding repository held in the first locking mechanism to the slide stage.

### FIELD OF THE INVENTION

The present invention is in the field of instruments and methods for printing information on a biological sample slide.

### BACKGROUND

Automated slide imaging systems are well-known in the art. These systems are generally designed to acquire and process images of specimen slides (e.g., biological specimen slides) in order to identify the location(s) of objects of interest on the respective slides, e.g., for facilitating subsequent human review of the slide by a cytotechnologist. The slides typically have a designated area adapted for the deposition of a specimen, which may be a cytological specimen, but may also be another type of specimen. By way of a well-known example, the cytological specimens may be prepared samples of cellular matter obtained from a cervical Pap smear. The Pap smear specimen slide is preferably a monolayer preparation, such as that provided by the Thin Prep slide preparation systems ThinPrep 2000® or ThinPrep 3000®, manufactured and distributed by Cytyc Corporation (www.cytyc.com), in which the cervical cells are disposed on the slide in a single layer to facilitate their imaging and analysis.

After the specimen is deposited on a slide, the specimen is typically stained to facilitate the viewing of the cells by a cytotechnologist. A cover slip is typically positioned over the specimen on the slide after the staining and before the viewing. The cover slip protects the specimen from being scraped off the slide accidentally.

It is often desirable to print certain identifying information or indicia on the slide. The indicia commonly contain information necessary for matching the results of an analysis with the correct patient, for example identification of the patient from whom the specimen on the slide was obtained either by name or by medical record number or both, or the doctor that provided the slide.

### SUMMARY OF THE INVENTION

In one embodiment, a slide printing system includes a printer comprising a slide stage and a print head; a first locking mechanism configured to hold a first slide-holding repository; and a slide handler configured to rotate about an axis for transporting a specimen slide held the slide-holding repository to the slide stage. The print head may be configured to print identifying indicia on the specimen slide. The slide stage may be configured to move with respect to the print head, or alternatively, the print head may be configured to move with respect to the slide stage.

The slide printing system may optionally comprise a scanner configured to scan a barcode located on a specimen slide, and/or a sensor configured to identify an orientation of a specimen slide positioned on the slide stage.

In alternative embodiments, the slide printing system may optionally comprise a second locking mechanism configured to hold a second slide-holding repository.

The print head may be an ink jet print head, and may be configured to print a character selected from the group consisting of alpha text, numeric digits, barcodes, and graphics.

In another aspect, the presently disclosed inventions include methods of printing identifying indicia on a biological specimen slide. In one embodiment, the method includes using an automated slide handler to remove a specimen slide from a first slide-holding repository and transport the specimen slide to a slide stage in close proximity to a print head using the automated slide handler; obtaining identifying indicia for the specimen slide; and printing the identifying indicia on the specimen slide. The identifying indicia can include, by way of example, a name or a record number (or both) for a patient. Optionally, the method may include placing the first slide-holding repository in close proximity of the slide handler prior to removing a slide therefrom.

In various embodiments, the method may optionally comprise scanning a barcode located on the specimen slide before obtaining the identifying indicia. The method may also optionally comprise transporting the specimen slide from the slide stage to the first slide-holding repository using the automated slide handler, after printing the identifying indicia. Alternatively, the method may optionally comprise transporting the slide from the slide stage to a second slide-holding repository using the automated slide handler, after printing the identifying indicia.

### BRIEF DESCRIPTION OF THE DRAWINGS

It will be appreciated that the drawings are not necessarily to scale, with emphasis instead being placed on illustrating the various aspects and features of embodiments of the invention, in which:

FIG. 1 is a top view of an embodiment of a specimen slide configured for use with the slide imaging system of FIG. 2.

FIG. 2 is a schematic view of an embodiment of a disclosed slide printing system.

FIG. 3 is a schematic view of another embodiment of a disclosed slide printing system having a separate slide-holding repository for printed slides.

### DETAILED DESCRIPTION OF THE ILLUSTRATED EMBODIMENTS

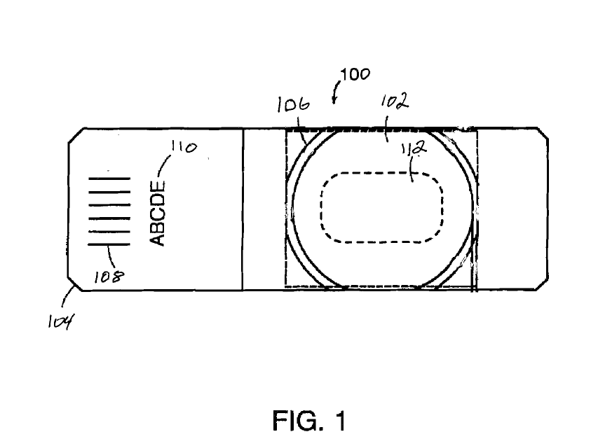

FIG. 1 is a top view of one embodiment of a microscope slide 100, which can be used with embodiments of the printing system disclosed herein. The slide 100 has a specimen area 102 adapted for the deposition of a sample, such as a cytological specimen 112, thereon. Typically, the slide 100 has toleranced dimensions and chamfered edges to facilitate handling and use of the slide 100 with automated (and calibrated) equipment, such as an automated imaging system. The slide 100 is preferably manufactured from glass, and has a width of about one inch, a length of about three inches, and a thickness of about 0.04 inches.

One end 104 of the slide 100 may be frosted or coated to facilitate marking and identification of the specimen 112 thereon in human readable form. The frosted end 104 may have an area of about one square inch. A frosted annulus 106, defining an area to where the cells are transferred, may also be provided to facilitate scanning of sparse specimens. The slide 100 may be marked with a barcode 108, as well as indicia 110 containing information necessary for matching the results of an analysis with the correct patient, for example identification of the patient from whom the specimen on the slide was obtained, or the doctor that provided the slide.

Typically, prior to depositing the specimen 112 on the slide 100, the slide 100 is marked with the barcode 108, which is permanently affixed to the slide 100. The barcode 108 does not wash away or erase upon exposure to chemicals used for staining the specimen 112. In some embodiments, the barcode 108 is printed on the slide 100 and then is covered with a glass or plastic cover slip. Alternatively, the barcode 108 is printed with permanent ink on a sticker and is then affixed to the end 104 of the slide 100. In other embodiments, the barcode 108 is printed directly on the end 104 of the slide 100 with permanent ink.

Prior to depositing the specimen 112 on the slide 100, the barcode 108 is scanned into a computer controller system (not shown). The scanned barcode 108 is then uniquely associated with the information on a sample vial, such as the name or medical record number of a patient, the name of the physician, etc. A specimen obtained from the sample vial uniquely associated with the scanned barcode 108 is then deposited on the slide 100, for example, by using a ThinPrep 2000® or ThinPrep 3000® slide preparation system.

The slide 100 is then stained and optionally cover slipped using either an automated system or manually, and then placed in a slide-holding repository 206 (see below). The slide-holding repository 206, holding a plurality of slides 100, is then placed in an automated imaging system for imaging the specimens 112. Examples of automated imaging systems are known in the art and include those described in U.S. Pat. Nos. 6,665,060 and 7,006,674, and U.S. patent application Ser. No. 11/554,493, by Hunt et al., filed on Oct. 30, 2006, all of which are incorporated by reference herein in their entirety.

It is often preferred to print the identifying indicia 110 on a biological slide after staining the specimen 112 and/or covering it with a cover slip. The chemicals used for staining at times wash away any printed material on the slide, which may result in the identifying information being lost. In some embodiments, the printing of the indicia 110 takes place after the staining process and before placing the slides 100 in an automated imaging system. Alternatively, the slides 100 are printed with indicia 110 after the imaging by an automated imaging system.

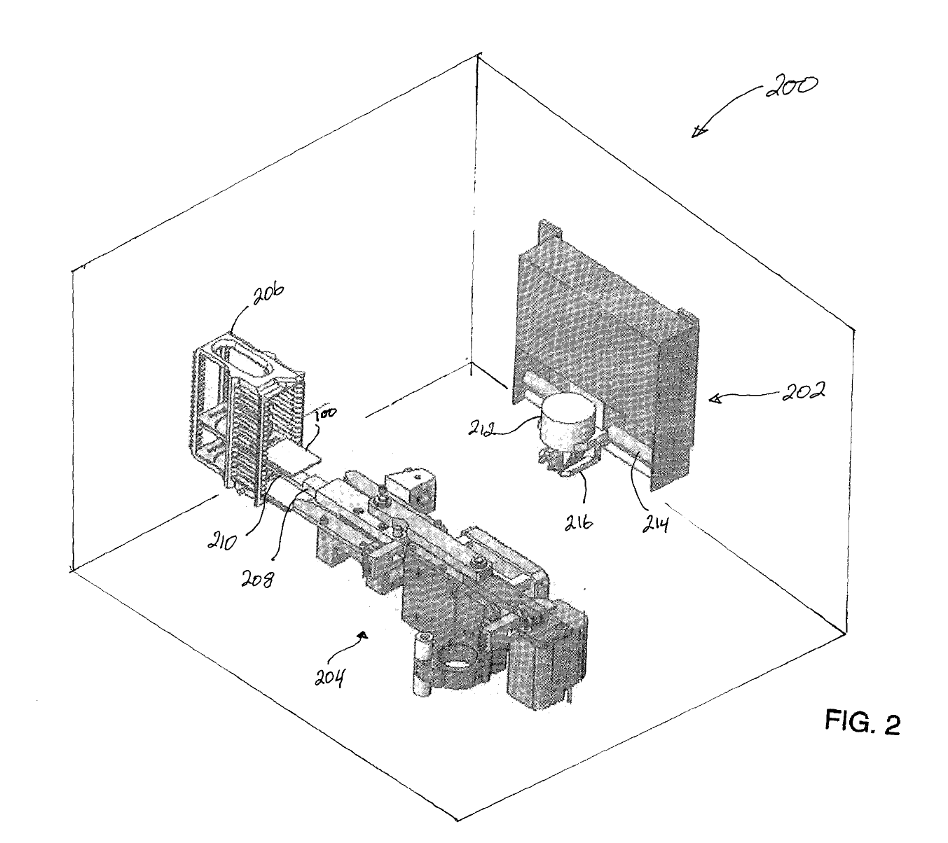

FIG. 2 is a schematic view of one embodiment of an automated printing system 200. Typically, after the slides are prepared, stained, and cover slipped, they are placed in a slide-holding repository 206 configured to hold multiple slides 100. The slide-holding repository 206 can be a box or a tray, and in one embodiment, such as the one shown in FIG. 2, is a cassette configured to hold multiple slides, each on an individual shelf. Each cassette 206 typically holds about 25 slides 100. The printing system 200 comprises a locking mechanism (not shown) into which the slide-holding repository 206 can be snapped in place. The locking mechanism can be a friction lock, or alternatively, it can comprise a nub and a groove, which when snapped together, hold the slide-holding repository in place. In other alternative embodiments, the locking mechanism comprises a latch that can be snapped in place behind the slide-holding repository. The locking mechanism may also comprise a screw that when screwed in place prevents the slide-holding repository from moving. The locking mechanism prevents the slide-holding repository 206 from moving within the printing system 200 throughout the printing process. An operator can snap the slide-holding repository 206 into and out of the locking mechanism. The printing system 200 can be configured to accept any of the slide cassettes or racks on the market.

The cassette 206 is shown in FIG. 2 without a cover. However, a cover, such as a plastic cover, will normally be used to cover the cassette 206 in order to prevent slide contamination with ambient dust or other contaminants, as well as to lower the risk of slide damage due to inadvertent contact with hard object.

A computer controller system (not shown) is provided to control the movements of the various parts of the printer system 200, as more fully explained below. The computer controller system further comprises further tracks the unique association between the barcode 108 and the identifying information associated therewith.

To start the process, an operator loads the slides 100 into a slide-holding repository 206 and places the slide-holding repository 206 in the locking mechanism of the printing system 200. The operator then starts the process by either pressing a button or entering a command on the computer controller system, which starts the automated printing process.

A slide handler 204, upon appropriate commands from the controller computer system, with which it is in electronic communication, retrieves the respective specimen slides 100 (i.e., one at a time) from their respective storage locations in a slide-holding repository 206, and places the slides 100 before the printer 202 (described below). After the indicia 110 on the slide 100 are printed, the slide handler 204 returns the slide to the slide-holding repository 206. In some embodiments, the slide handler 204 pivots about an axis (not shown), and can reach the various components in the system, such as the slide-holding repository 206, the slides 100, and the printer 202.

The slide handler 204 comprises a robotic arm 208, which is configured to move longitudinally in and out of the slide handler 204. The slide handler 204 is configured to move up and down with respect to the printer 202 and the slide-holding repository 206. Therefore, the robotic arm 208 can reach any of the slides in the slide-holding repository 206. The robotic arm 208 has a distal terminus 210 configured to grasp a slide 100 and securely transport it to and fro the printer 202.

The printer 202 comprises a print head 212, an axis 214, and a slide stage 216. In one embodiment, the print head 212 mounted on the axis 214 and is configured to move laterally along the axis 214, while the slide stage 216 is stationary. In alternative embodiments, the print head 212 is stationary and the slide stage 216 is configured to move laterally along the axis 214. The printer 202 optionally comprises a barcode scanner (not shown) in close proximity to the print head 212. The printer 202, and the optional barcode scanner, are in electronic communication with the computer controller system and can transmit and receive data therebetween.

Sensors (not shown), such as optical sensors, can optionally be provided in close proximity to the printer head. The sensors detect the location of the slide 100 on the slide stage 216 and determine whether the slide 100 is properly loaded on the slide stage 216. If the slide 100 is not properly loaded, the slide handler 204 adjusts the slide 100 on the slide stage 216 until the proper positioning is achieved.

To print the indicia 110 on the slide 100, the robotic arm 208 of the slide handler 204 obtains a slide 100 from the slide-holding repository 206 and transports it to slide stage 216. In some embodiments, the robotic arm 208 continues to hold onto the slide 100 during the printing process. In alternative embodiments, the robotic arm 208 releases the slide 100 on the slide stage 216. In these embodiments, the slide stage 216 is configured to hold the slide 100 in place to minimize or eliminate its movements on the slide stage 216 during the printing process.

In the embodiments where a barcode scanner is provided, the barcode scanner scans the barcode 108 of the slide 100 and transmits the information to the computer controller system and receives identifying information associated with the particular barcode 108. Upon command from the computer controller system, the print head 212 prints the indicia 110 corresponding to the identifying information received from the computer controller system on the end 104 of the slide 100.

In alternative embodiments, the barcodes 108 of the slides 100 are scanned prior to the placement of the slides in the slide-holding repository 206. In these embodiments, the location of the slides 100 in the slide-holding repository 206 is uniquely associated with the particular barcodes 108. The computer controller system instructs the slide handler 204 to obtain a slide 100 from a particular location in the slide-holding repository 206 and transmits the unique identifying information associated with that particular slide 100 to the printer 202 for printing.

In some embodiments, the print head 212 is an ink jet print head. As a slide 100 passes the print head 212, either by the print head 212 moving with respect to the slide stage 216 or the slide stage 216 moving with respect to the print head 212, the identifying information stored in the computer controller system is printed onto the end 104 of the slide 100.

The print head 212 is configured to print alpha text, numeric digits, additional barcodes, if necessary, and graphics, depending on the particular indicia 110 required to be printed on the slide 100.

At the completion of the printing, and upon a command from the computer controller system, the slide handler 204 retrieves the slide 100 from the slide stage 216 and returns it to its location in the slide-holding repository 206. The slide handler 204 then obtains a second slide 100 and transports it to the printer 202 for printing. This process is continued until all of the slides in the slide-holding repository 206 have undergone the printing step.

The printing system 200 may further comprise a drying station (not shown) configured to dry the ink on the slide 100. The drying station may be configured to blow warm air over the ink to affect the drying. The drying step can take place on the slide stage 216. Alternatively, the drying step can take place at the completion of the printing process for a slide-holding repository 206 and after all of the slides 100 have been transported back to the slide-holding repository 206.

An alerting system (not shown) is provided that alerts the operator to the completion of the printing for the particular slide-holding repository 206. The operator can then remove the slide-holding repository 206 from the printer system 200, and optionally position another slide-holding repository 206 therein.

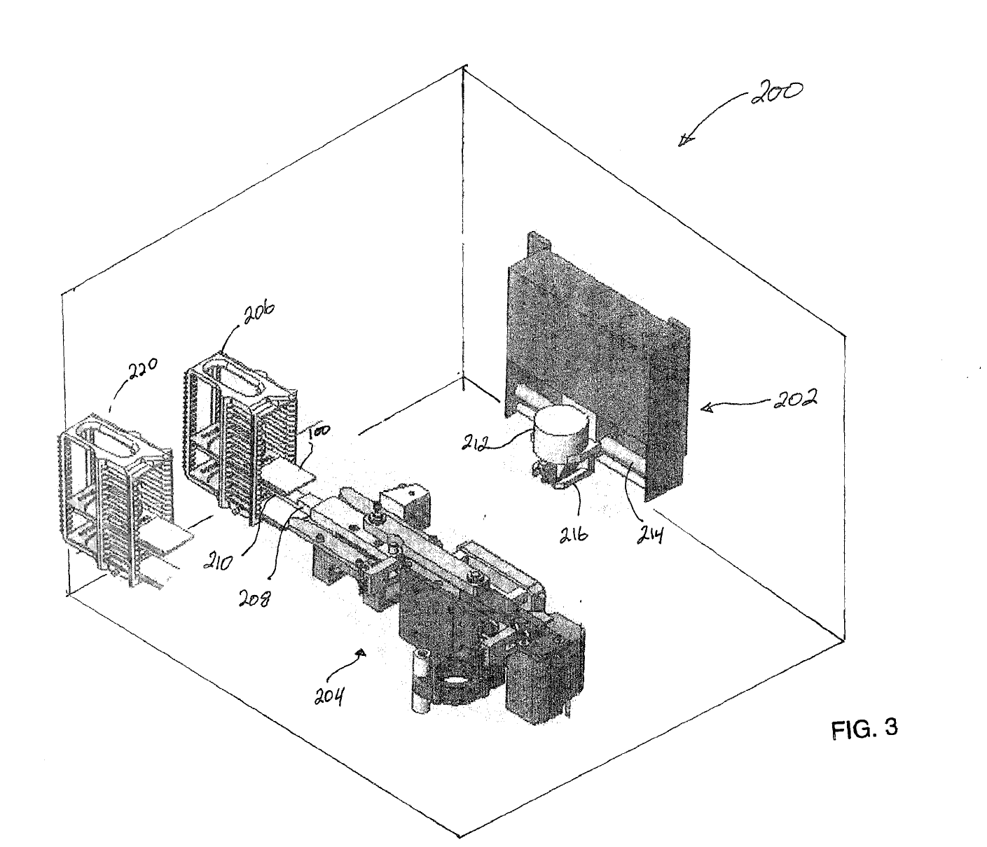

In alternative embodiments, as shown in FIG. 3, the operator positions a separate slide-holding repository 220 in the printer system 200 in addition to the slide-holding repository 206. The slide handler 204 retrieves the slides 100 from the slide-holding repository 206 and transports them to the slide stage 216. Following the printing, the slide handler 204 retrieves the slides 100 from the slide stage 216 and transports them to the slide-holding repository 220. When all of the slides 100 have been printed and transported to the slide-holding repository 220 the printer system 200 alerts the operator, who removes both slide-holding repositories 206 and 220 from the printer system 200 and, optionally, replaces them with a new slide-holding repository 206 containing slides 100 and a new empty slide-holding repository 220.

Although particular embodiments of the present invention have been shown and described, it should be understood that the above discussion is not intended to limit the present invention to these embodiments, and it will be readily apparent to those skilled in the art that various changes and modifications may be made without departing from the invention, as defined by the claims.

What is claimed is:

1. A slide printing system, comprising:
a printer comprising a slide stage and a print head;
a first locking mechanism configured to hold a first slide-holding repository; and
a slide handler configured to rotate about an axis for transporting a specimen slide from a slide-holding repository held in the first locking mechanism to the slide stage.

2. The system of claim 1, wherein the print head is configured to print identifying indicia on a specimen slide.

3. The system of claim 1, wherein the slide stage is movable relative to the print head.

4. The system of claim 1, wherein the print head is movable relative to the slide stage.

5. The system of claim 1, further comprising a scanner configured to scan a barcode located on a specimen slide.

6. The system of claim 1, further comprising a sensor configured to identify an orientation of a specimen slide positioned on the slide stage.

7. The system of claim 1, further comprising a second locking mechanism configured to hold a second slide-holding repository.

8. The system of claim 1, wherein the print head is an ink jet print head.

9. The system of claim 1, wherein the print head is configured to print a character selected from the group consisting of alpha text, numeric digits, barcodes, and graphics.

10. A slide printing system, comprising:
a printer comprising a slide stage and a print head, wherein the print head is configured to print identifying indicia on a specimen slide, and wherein the print head and slide stage are movable relative to one another;
a first locking mechanism configured to hold a first slide-holding repository;
a slide handler configured to rotate about an axis for transporting a specimen slide from a slide-holding repository held in the locking mechanism to the slide stage; and
a scanner configured to scan a barcode located on a specimen slide.

11. The system of claim 10, further comprising a sensor configured to identify an orientation of a specimen slide positioned on the slide stage.

12. The system of claim 10, further comprising a second locking mechanism configured to hold a second slide-holding repository.

13. The system of claim 10, wherein the print head is configured to print a character selected from the group consisting of alpha text, numeric digits, barcodes, and graphics.

14. A method of printing identifying indicia on a specimen slide, comprising:
using an automated slide handler to remove a specimen slide from a first slide-holding repository and transport the specimen slide to a slide stage located in close proximity to a print head;
obtaining identifying indicia for the specimen slide; and
printing the identifying indicia on the specimen slide using the print head.

15. The method of claim 14, further comprising scanning a barcode located on the specimen slide before obtaining the identifying indicia.

16. The method of claim 14, further comprising using the automated slide handler to transport the specimen slide from the slide stage to the first slide-holding repository, after printing the identifying indicia.

17. The method of claim 14, wherein the identifying indicia comprises one or both of a name and a record number.

18. The method of claim 14, further comprising using the automated slide handler to transport the specimen slide from the slide stage to a second slide-holding repository, after printing the identifying indicia.

19. The method of claim 14, further comprising positioning the first slide-holding repository in close proximity of the slide handler prior to removing a slide therefrom.
